(19) United States
(12) Patent Application Publication
(10) Pub. No.: US 2011/0110032 A1
(43) Pub. Date: May 12, 2011

(54) BRACKET ASSEMBLY

(75) Inventors: Che-Yu KUO, Tu-Cheng (TW); Li-Ping CHEN, Tu-Cheng (TW)

(73) Assignee: HON HAI PRECISION INDUSTRY CO., LTD., Tu-Cheng (TW)

(21) Appl. No.: 12/650,577

(22) Filed: Dec. 31, 2009

(30) Foreign Application Priority Data
Nov. 11, 2009 (CN) 200920314557.7

(51) Int. Cl. F16M 13/00; G06F 1/16

(52) U.S. Cl. 361/679.58; 248/291.1; 248/292.13

(57) ABSTRACT

A bracket assembly is used for an expansion card. The bracket assembly includes a panel and a handle. The panel includes a top edge. The handle is attached to a side of the panel. The handle is capable of pivoting about a pivot axis perpendicular to the panel. The handle includes a lifting arm, a blocking arm, and a connecting arm. The lifting arm, the blocking arm and the connecting arm are connected end to end. An opening is defined by the lifting arm, the blocking arm and the connecting arm. The handle is capable of being rotated between a first position where the handle is urged to reside under the top edge of the panel and a second position where the opening extend above the top edge of the panel.

### BACKGROUND

1. Technical Field

The present disclosure relates to brackets, especially to a removable bracket assembly for receiving an expansion card in a computer.

2. Description of Related Art

Expansion cards are widely used in computers and servers. When many expansion cards are needed in a computer, a riser card may be utilized. A riser card and the expansion cards are usually placed in a bracket. The bracket includes a bottom wall, a front wall, and at least one sidewall. When one or more of expansion card needs to be changed, the bracket is removed by manually pulling on the side walls, which can cause damage to the expansion cards or other electronic elements in the computer.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a computer in accordance with an embodiment.

FIG. 2 is an exploded, isometric view of a bracket and a handle of FIG. 1 from another aspect.

FIG. 3 is a front view of the handle of FIG. 1.

FIG. 4 is an assembled view of the handle and the bracket of FIG. 1, showing a position the handle assumes when a top cover is installed on a chassis.

FIG. 5 is similar to FIG. 4, but showing a position the handle assumes when the top cover is not in place.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

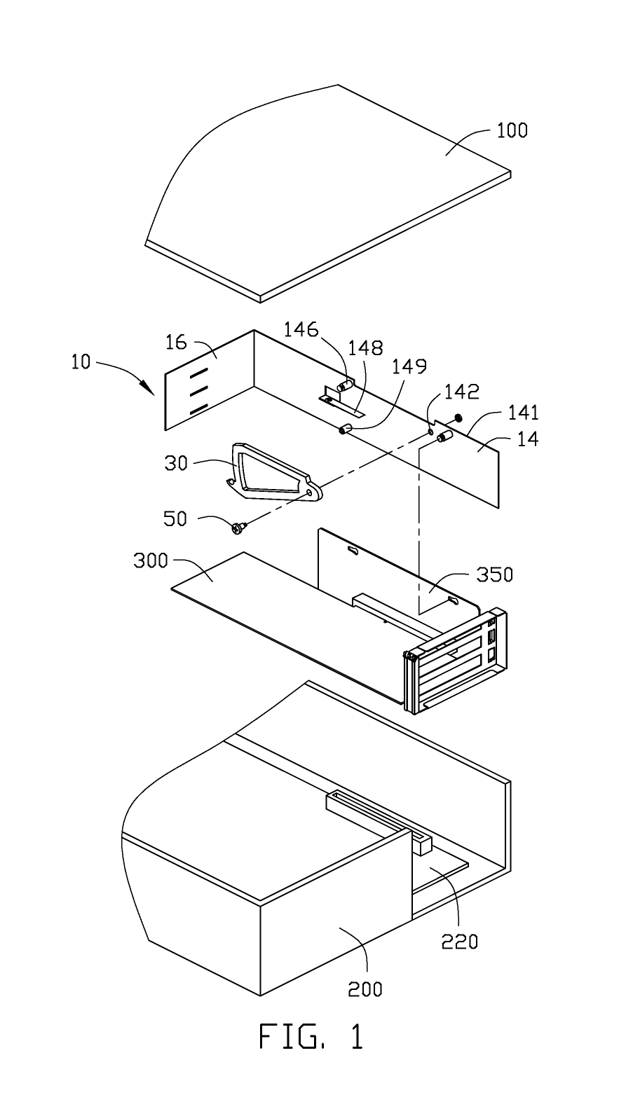

Referring to FIG. 1, a computer includes a chassis 200, a motherboard 220, a riser card 350, an expansion card 300 connecting to the riser card 350, a bracket 10, a handle 30, and a top cover 100.

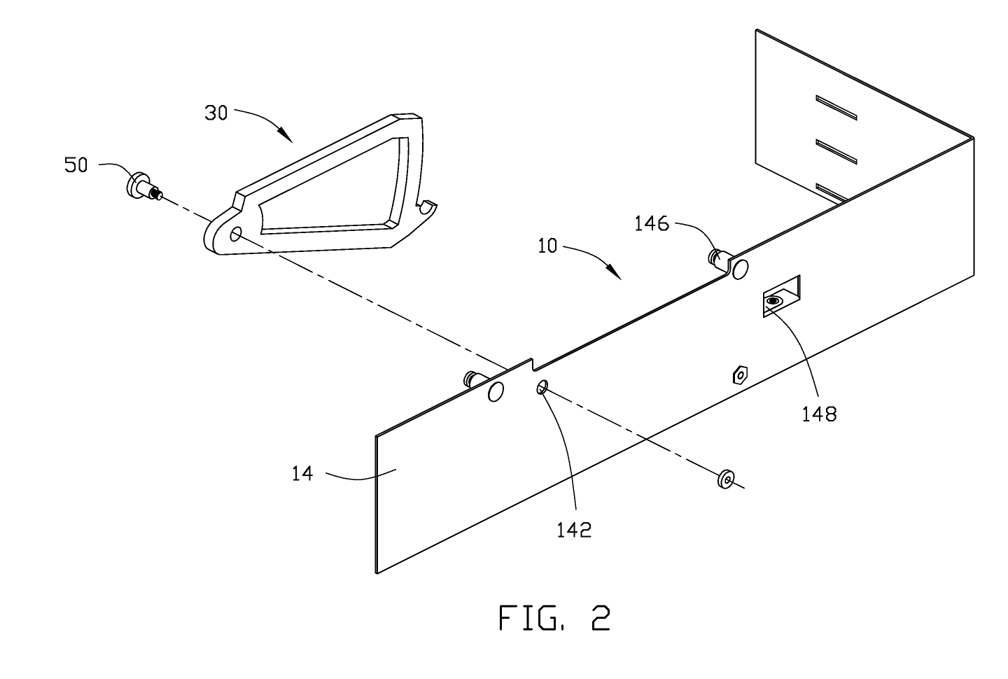

Referring to FIG. 1 and FIG. 2, the bracket 10 includes a front panel 14 and a side panel 16. An upper stopper 146 and a lower stopper 149 protrude from the front panel 14. The upper stopper 146 and the lower stopper 149 are posts. A pivot hole 142 is defined in the front panel 14. A resilient member 148 is attached to the front panel 14. The resilient member 148 is an elastic clip. The front panel 14 has a top edge 141.

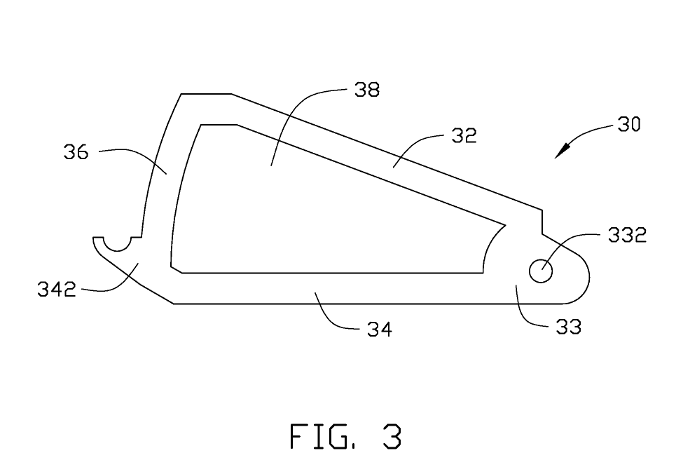

Referring to FIG. 3, the handle 30 includes a lifting arm 32, a blocking arm 34, and a connecting arm 36. The lifting arm 32, the blocking arm 34, and the connecting arm 36 are connected end to end. An opening 38 is defined encircled by the lifting arm 32, the blocking arm 34, and the connecting arm 36. The opening 38 is sector shaped.

The handle 30 has a pivot portion 33 at a joint portion of the lifting arm 32 and the blocking arm 34. A pivot hole 332 is defined in the pivot portion 33. A blocking portion 342 extends from an end of blocking arm 34 away from the pivot portion 33.

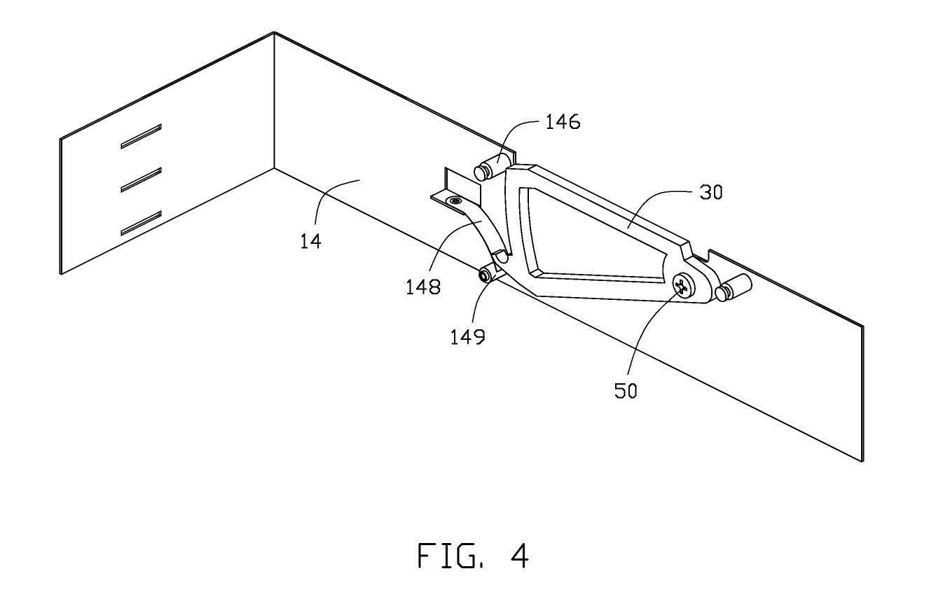

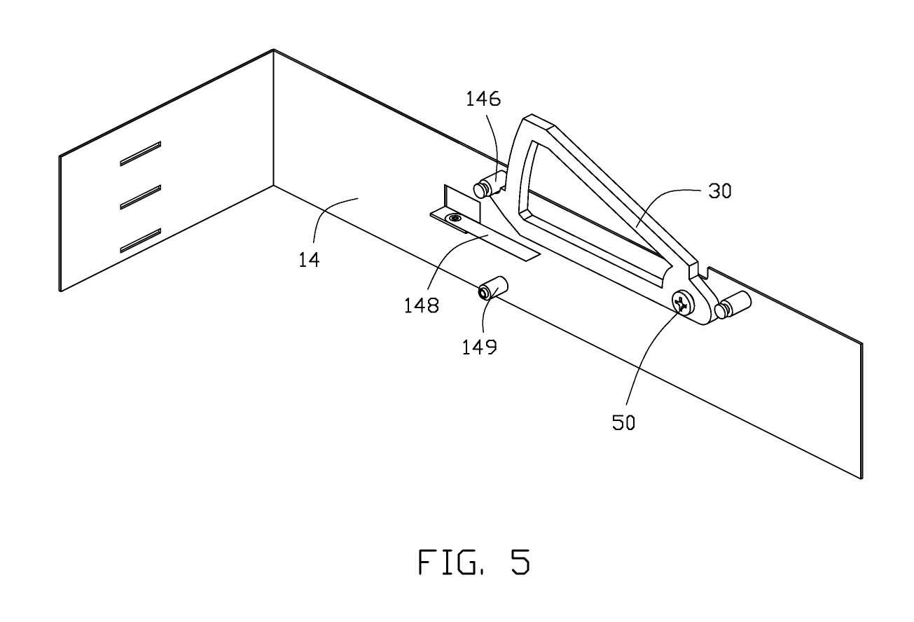

Referring to FIG. 4 and FIG. 5, in assembly, the handle 30 is pivotably attached to the front panel 14 by a fastener 50 extending through the pivot hole 332 and the pivot hole 142 (see FIG. 2). The handle 30 pivots about a pivot axis perpendicular to the front panel 14. An end of the resilient member 148 abuts the handle 30 to provide resilient force to the handle 30. The lifting arm 32 is moved out of the chassis 200 by the resilient force of the resilient member 148. Part of opening 38 is above the top edge 141 of the front panel 14 to allow insertion of fingers to lift up the chassis 200. The motherboard 220 is installed in the chassis 200. The expansion card 300 is connected to the riser card 350, and the riser card 350 is mounted to the bracket 10 and connected to the motherboard 220. The top cover 100 is mounted on the chassis 200. The handle 30 is pressed down by the top cover 100. The handle 30 resides within the chassis 200 under the top edge 141 of the front panel 14. The resilient member 148 is resiliently deformed down. The lower stopper 149 blocks the handle 30 at a downward direction.

When the top cover 100 is removed from the chassis 200. The handle 30 rotates upward from the chassis 200 due to the resilient force of the resilient member 148 until the block portion 342 is blocked by the upper stopper 146. The bracket 10 then can be removed upward by the handle 30.

It is also to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A bracket assembly for receiving an expansion card, the bracket assembly comprising:
a panel comprising a top edge; and
a handle attached to a side of the panel, the handle capable of pivoting about a pivot axis perpendicular to the panel, the handle comprising:
a lifting arm;
a blocking arm; and
a connecting arm;
wherein the lifting arm, the blocking arm and the connecting arm are connected end to end; an opening is defined by the lifting arm, the blocking arm and the connecting arm; the handle is capable of being rotated between a first position where the handle is urged to reside under the top edge of the panel and a second position where the opening extends above the top edge of the panel.

2. The bracket assembly of claim 1, wherein an upper stopper protrudes from the panel and the upper stopper is capable of blocking the handle from rotating out of the panel.

3. The bracket assembly of claim 2, wherein a blocking portion extends from an end of the blocking arm corresponding to the upper stopper.

4. The bracket assembly of claim 1, wherein the pivot axis extends through a joint portion of the lifting arm and the blocking arm.

5. The bracket assembly of claim 1, wherein a resilient member is attached to the panel and the resilient member is capable of providing resisting force to the handle at the first position.

6. The bracket assembly of claim 5, wherein the resilient member is an elastic clip and a free end of the elastic clip is capable of abutting on the handle.

7. The bracket assembly of claim 1, wherein a lower stopper protrudes from the panel and the lower stopper is capable of supporting the handle at the first position.

8. The bracket assembly of claim 1, wherein the lifting arm exceeds the top edge of the panel and the blocking arm is positioned below the top edge of the panel at the first position.

9. The bracket assembly of claim 1, wherein the opening has a sector configuration.

10. A computer comprising:
a chassis;
a motherboard received in the chassis;
a bracket assembly comprising:
a panel; and
a handle attached to a side of the panel, the handle capable of pivoting about a pivot axis perpendicular to the panel, the handle defining an opening;
a riser card mounted to the bracket assembly and connecting to the motherboard;
at least one expansion card connecting to the riser card; and
a top cover mounting on the chassis, and the top cover capable of preventing the handle from rotating out of the chassis;
wherein the handle is capable of rotating out of the chassis when the top cover is removed from the chassis.

11. The bracket assembly of claim 10, wherein an upper stopper protrudes from the panel and the upper stopper is capable of blocking the handle from rotating out of the panel.

12. The bracket assembly of claim 11, wherein a blocking portion extends from the handle corresponding to the upper stopper.

13. The bracket assembly of claim 10, wherein the handle comprising a lifting arm, a blocking arm, and a connecting arm; the lifting arm, the blocking arm and the connecting arm are connected end to end.

14. The bracket assembly of claim 13, wherein the pivot axis extends through a joint portion of the lifting arm and the blocking arm.

15. The bracket assembly of claim 13, wherein the lifting arm exceeds the chassis and the blocking arm is positioned within the chassis when the top cover is removed from the chassis.

16. The bracket assembly of claim 10, wherein a resilient member is attached to the panel and the resilient member is capable of providing resisting force to the handle.

17. The bracket assembly of claim 16, wherein the resilient member is an elastic clip, and a free end of the elastic clip is capable of abutting on the handle.

18. The bracket assembly of claim 10, wherein a lower stopper protrudes from the panel and the lower stopper is capable of supporting the handle.

19. The bracket assembly of claim 10, wherein the opening has a sector configuration.
